(19) United States
(12) Patent Application Publication
(10) Pub. No.: US 2026/0299795 A1
(43) Pub. Date: Oct. 1, 2026

(54) MEMORY CONTROLLER FOR ADJUSTING BACKGROUD OPERATION SCHEDULE BASED ON TEMEPRATURE, MEMORY SYSTEM, AND OPERATING METHOD THEREOF

(71) Applicant: Yangtze Memory Technologies Co., Ltd., Wuhan (CN)

(72) Inventors: Fangqi Ge, Wuhan (CN); Chao Wu, Wuhan (CN)

(21) Appl. No.: 19/097,300

(22) Filed: Apr. 1, 2025

(30) Foreign Application Priority Data
Mar. 27, 2025 (CN) 202510376669.9

(51) Int. Cl. G06F 3/06

(52) U.S. Cl. CPC G06F 3/0619; G06F 3/0659; G06F 3/0679

(57) ABSTRACT

In certain aspects, a disclosed memory system comprises a memory device and a memory controller coupled to the memory device. The memory controller is configured to control the memory device to perform at least a first subset of a group of background operations based on a first schedule; transmit a notification to a host indicating a low temperature event of the memory device; and, in response to an instruction from the host, control the memory device to perform at least a second subset of the group of background operations based on a second schedule different from the first schedule to increase a temperature associated with the memory device.

### CROSS-REFERENCE TO RELATED APPLICATIONS

The present application claims the benefit of priority to Chinese Application No. 202510376669.9, filed on Mar. 27, 2025, which is hereby incorporated by reference in its entirety.

### BACKGROUND

The present disclosure relates to memory controllers, memory systems, and operating methods thereof.

Non-volatile storage devices such as solid-state drives (SSDs), non-volatile memory express (NVMe), embedded multimedia cards (eMMCs), and universal flash storage (UFS) devices, etc., have gained significant popularity in recent years due to their numerous advantages over traditional hard disk drives (HDDs), such as faster read and write speed, durability and reliability, reduced power consumption, silent operation, and smaller form factors. For example, non-volatile storage devices such as SSDs may use NAND Flash memory for non-volatile storage. Various operations can be performed by NAND Flash memory, such as read, program (write), and erase.

### SUMMARY

In one aspect, a memory system comprises a memory device, and a memory controller coupled to the memory device and configured to: control the memory device to perform at least a first subset of a group of background operations based on a first schedule; transmit a notification to a host indicating a low temperature event of the memory device; and in response to an instruction from the host, control the memory device to perform at least a second subset of the group of background operations based on a second schedule different from the first schedule to increase a temperature associated with the memory device.

In some implementations, the group of background operations comprises: background operations of one or more of garbage collection, wear leveling, write booster, bad block management, wipe, defragmentation, and data retention management.

In some implementations, the first schedule indicates a first frequency of performing a first type of background operation in the first subset; the second schedule indicates a second frequency of performing the first type of background operation in the second subset; and the second frequency is greater than the first frequency.

In some implementations, the memory controller is further configured to: obtain the temperature associated with the memory device; and determine the low temperature event in response to the temperature being lower than a first threshold temperature or a decrease of the temperature being greater than a preset value.

In some implementations, the memory controller is further configured to: in response to a permission indicated by the instruction, enable an auto-determine algorithm to determine the second schedule based on the temperature and a storage condition of the memory device.

In some implementations, the memory controller is further configured to: in response to a host selection indicated by the instruction, select, from a plurality of predetermined schedule options, the second schedule corresponding to the host selection.

In some implementations, the memory controller is further configured to: in response to the temperature being higher than a second threshold temperature, control the memory device to perform at least a third subset of a group of background operations based on a third schedule different from the second schedule.

In some implementations, the memory controller is further configured to: generate a real-time status report of the background operations and the temperature; and send the real-time status report to the host.

In another aspect, a method comprises: controlling a memory device to perform at least a first subset of a group of background operations based on a first schedule; transmitting a notification to a host indicating a low temperature event of the memory device; and in response to an instruction from the host, controlling the memory device to perform at least a second subset of the group of background operations based on a second schedule different from the first schedule to increase a temperature associated with the memory device.

In another aspect, a non-transitory computer-readable storage medium comprising instructions that, when executed by a memory controller coupled with a memory device, cause the memory controller to perform a method comprising: controlling the memory device to perform at least a first subset of a group of background operations based on a first schedule; transmitting a notification to a host indicating a low temperature event of the memory device; and in response to an instruction from the host, controlling the memory device to perform at least a second subset of the group of background operations based on a second schedule different from the first schedule to increase a temperature associated with the memory device.

In another aspect, an electronic device, comprising: a host; a memory device; and a memory controller coupled to the memory device and configured to: control the memory device to perform at least a first subset of a group of background operations based on a first schedule; transmit a notification to a host indicating a low temperature event of the memory device; and in response to an instruction from the host, control the memory device to perform at least a second subset of the group of background operations based on a second schedule different from the first schedule to increase a temperature associated with the memory device.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1 illustrates a block diagram of a system including a memory system, according to some aspects of the present disclosure.

FIG. 2A illustrates a diagram of a memory card having a memory device, according to some aspects of the present disclosure.

FIG. 2B illustrates a diagram of an SSD having memory devices, according to some aspects of the present disclosure.

FIG. 3A illustrates a block diagram of a memory controller, according to some aspects of the present disclosure.

FIG. 3B illustrates example interactions between a memory controller and a non-volatile (NV) memory device, according to some aspects of the present disclosure.

FIG. 4 illustrates a schematic diagram of a NAND Flash memory device including peripheral circuits, according to some aspects of the present disclosure.

FIG. 5 illustrates an exemplary logic structure of the non-transitory computer-readable storage medium, according to some aspects of the present disclosure.

FIG. 6 illustrates an example process for operating a memory system, according to some aspects of the present disclosure.

FIG. 7A illustrates an example operation sequence for memory device temperature management, according to some aspects of the present disclosure.

FIG. 7B illustrates another example operation sequence for memory device temperature management, according to some aspects of the present disclosure.

FIG. 8 illustrates an example operation sequence for memory device temperature management, according to some aspects of the present disclosure.

FIG. 9 illustrates a flowchart of a method for operating a memory controller, according to some aspects of the present disclosure.

The present disclosure will be described with reference to the accompanying drawings.

### DETAILED DESCRIPTION

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Background Operations (BKOPS) refer to a set of maintenance and optimization tasks automatically performed by storage systems without direct user intervention. Designed to enhance performance, reliability, lifespan, and resource efficiency, BKOPS mechanisms vary across storage technologies such as SSDs, HDDs, UFS, and eMMC. Their core purpose is to manage critical behind-the-scenes processes that ensure seamless operation. For instance, in NAND-based storage like SSDs, BKOPS includes garbage collection to consolidate valid data and erase invalid blocks, reducing write amplification and freeing space. Wear leveling dynamically distributes write cycles across memory cells to prevent premature wear-out, a vital feature for flash storage with limited endurance. Additionally, BKOPS handles bad block management by identifying and replacing faulty storage units, while data refresh counteracts charge leakage in NAND cells by rewriting vulnerable data. Collaboration with operating systems, such as through the TRIM command, further optimizes efficiency by marking unused data regions for faster cleanup.

BKOPS operates transparently during idle periods or low system activity to minimize user disruption. This automation not only extends device longevity but also prevents performance degradation over time-common issues in heavily used storage media. In consumer devices like smartphones and laptops, BKOPS mitigates lag caused by fragmented data, while enterprise storage systems leverage it to maintain consistent throughput under high workloads. However, challenges persist, such as balancing resource consumption (e.g., power or compute overhead) in resource-constrained environments and avoiding latency spikes if background tasks conflict with active user operations. As storage technologies evolve, particularly with advancements like 3D NAND and QLC/PLC flash, adaptive BKOPS strategies become increasingly critical to address higher complexity and density. Overall, BKOPS represents a foundational pillar of modern storage design, enabling devices to self-maintain, optimize, and deliver reliable performance without compromising user experience.

Further, modern memory systems, such as NAND flash memory or DRAM systems, often require robust temperature management to ensure reliability, performance, and longevity. Temperature fluctuations, particularly low-temperature events, can adversely affect memory performance and data integrity. For example, non-volatile memory devices, such as NAND Flash memory devices, are sometimes used in an extremely cold environment, for example, in mobile devices or vehicles with an outdoor temperature below minus 20 or even 30 degrees Celsius. In an extremely cold environment, mobile devices or vehicles using non-volatile memory devices may not be launched due to the failure of reading system boot files stored in the non-volatile memory devices. Even after launching, read errors may still occur to the non-volatile memory devices caused by the low temperature that exceeds the normal working temperature range when reading data from the non-volatile memory devices. These issues may be caused by the large temperature difference between when the data is programmed into the memory device and when the data is read from the memory device that exceeds the temperature working range/band of the memory devices. These issues are getting worse when the performance of NAND Flash memory devices increases, e.g., with more stacked layers and/or bits per cell.

To address one or more of the aforementioned issues, the present disclosure introduces a low-temperature mode for a memory controller in which the memory controller can cause the temperature associated with the memory device to increase in a cold environment, thereby narrowing the temperature difference between data reading and writing. In the low-temperature mode, the memory controller can control the memory device and/or the memory controller to execute a low-temperature background operation schedule to intelligently manage background operations to influence the temperature of the memory device. The low-temperature background operation schedule can increase the operation frequency of performing one or more background operations to generate more heat from the memory device and/or the memory controller to heat up the memory device directly or indirectly, while maintaining the capability of handling normal operations. The present disclosure also provides various schemes for triggering the memory controller to enter and exit the low-temperature mode based on threshold temperatures. As a result, the low-temperature performance of non-volatile memory devices can be significantly improved.

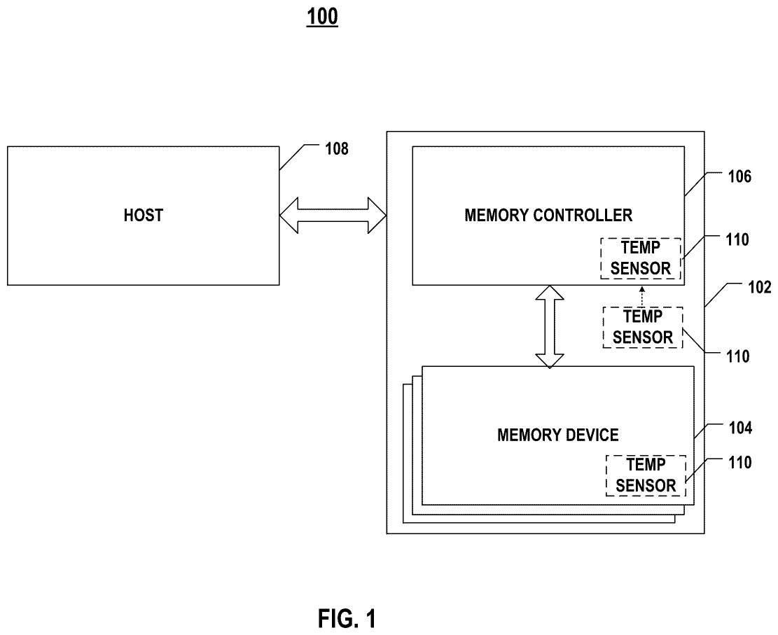

FIG. 1 illustrates a block diagram of a system 100 including a memory system 102, according to some aspects of the present disclosure. System 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, system 100 can include a host 108 and memory system 102 having one or more memory devices 104 and a memory controller 106. Host 108 can be a processor of an electronic device, such as a central processing unit (CPU), or a system-on-chip (SoC), such as an application processor (AP). Host 108 can be configured to send or receive data (a.k.a. user data or host data) to or from memory system 102. Memory system 102 can be a storage product integrating memory controller 106 and one or more memory devices 104, such as an SSD or a memory card.

Memory devices 104 can be any memory devices disclosed in the present disclosure, including non-volatile memory devices, such as NAND Flash memory devices. In some implementations, memory device 104 also includes one or more volatile memory devices, such as dynamic random-access memory (DRAM) devices.

Memory controller 106 is coupled to memory devices 104 and host 108 and is configured to control memory devices 104, according to some implementations. Memory controller 106 can manage the data stored in memory devices 104 and communicate with host 108. In some implementations, memory controller 106 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment with SSDs or embedded multimedia card (eMMCs) used as data storage for mobile devices, such as smartphones, tablets, laptop computers, etc., vehicles, and enterprise storage arrays. Memory controller 106 can be configured to control operations of memory devices 104, such as read, program/write, and/or erase operations. Memory controller 106 can also be configured to manage various functions with respect to the data stored or to be stored in memory devices 104, such as address translation including logical-to-physical (L2P) address conversion, and various background operations (BKOPS) including, but not limited to bad-block management, garbage collection, wear-leveling, write booster, etc. In some implementations, memory controller 106 is further configured to process error correction codes (ECCs) with respect to the data read from or written to memory devices 104. Any other suitable functions may be performed by memory controller 106 as well, such as formatting memory devices 104. Memory controller 106 can communicate with an external device (e.g., host 108) according to a particular communication protocol. For example, memory controller 106 may communicate with the external device through at least one of various interface protocols, such as a non-volatile memory express (NVMe) protocol, an NVMe-over-fabrics (NVMe-oF) protocol, a PCI-express (PCI-E) protocol, a universal serial bus (USB) protocol, a multimedia card (MMC) protocol, a peripheral component interconnection (PCI) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

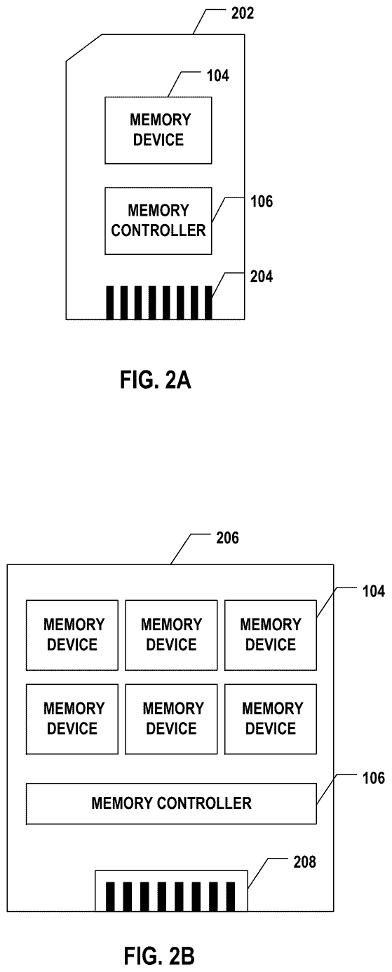

Memory controller 106 and one or more memory devices 104 can be integrated into various types of storage devices, for example, being included in the same package, such as a universal Flash storage (UFS) package or an eMMC package. That is, memory system 102 can be implemented and packaged into different types of end electronic products. In one example as shown in FIG. 2A, memory controller 106 and a single memory device 104 may be integrated into a memory card 202. Memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 202 can further include a memory card connector 204 coupling memory card 202 with a host (e.g., host 108 in FIG. 1). In another example as shown in FIG. 2B, memory controller 106 and multiple memory devices 104 may be integrated into an SSD 206. SSD 206 can further include an SSD connector 208 coupling SSD 206 with a host (e.g., host 108 in FIG. 1). In some implementations, the storage capacity and/or the operation speed of SSD 206 is greater than those of memory card 202. In some implementations, memory system 102 is implemented as an SSD 206 that includes both non-volatile memory devices and volatile memory devices as memory devices 104, such as an enterprise SSD.

Referring back to FIG. 1, consistent with the scope of the present disclosure, memory system 102 can also include one or more temperature sensors 110 configured to measure the temperatures associated with memory system 102. Temperature sensors 110 can be any suitable type, such as negative temperature coefficient (NTC) thermistors, thermocouples, resistance temperature detectors (RTDs), semiconductor-based temperature sensors, etc. As shown in FIG. 1, temperature sensor 110 can be integrated to or disposed on memory controller 106, integrated to or disposed on memory device 104, and/or separated from memory controller 106 and 104 within the package of memory system 102. In some implementations, temperature sensor 110 is integrated to or disposed on memory device 104 and configured to measure the temperature of memory device 104 directly. The measured temperature can be transmitted to memory controller 106. In some implementations, temperature sensor 110 is integrated to or disposed on memory device 104 and configured to measure the temperature of memory controller 106 directly. The temperature of memory controller 106 can be converted to the temperature of memory device 104 based on, for example, the distance between memory controller 106 and memory device 104, the thermal conductivity of the medium between memory controller 106 and memory device 104, and the volume of the package enclosing memory controller 106 and memory device 104. In some implementations, temperature sensor 110 is a standalone component separate from memory controller 106 and memory device 104 and configured to measure the ambient temperature within the package of memory system 102. The measured temperature can be transmitted to memory controller 106 as well. Likewise, the ambient temperature can be converted to the temperature of memory device 104 based on, for example, the distance between temperature sensor 110 and memory device 104, the thermal conductivity of the medium between temperature sensor 110 and memory device 104, and the volume of the package enclosing memory controller 106 and memory device 104. In any event, one or more temperature sensors 110 can provide temperatures associated with different parts of memory system 102 to memory controller 106, such that memory controller 106 can obtain the temperature associated with memory device 104. It is understood that in some examples, temperature sensors 110 can provide the measurements to host 108 directly, such that host 108 can obtain the temperature associated with memory device 104.

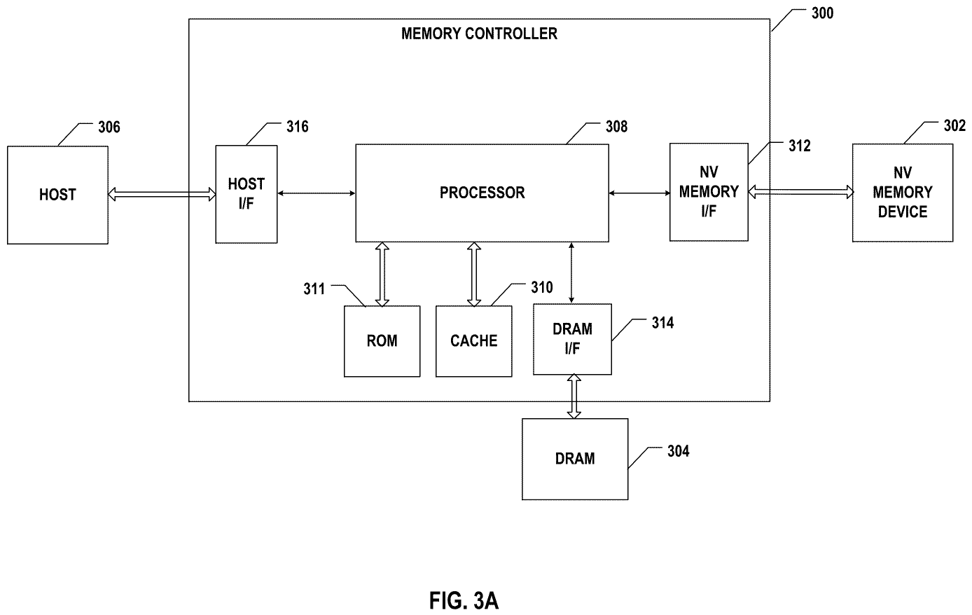

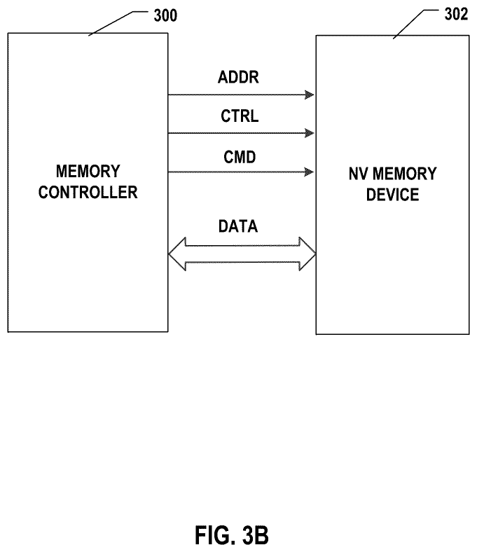

FIG. 3A illustrates a block diagram of a memory controller 300, according to some aspects of the present disclosure. Memory controller 300 may be one example of memory controller 106 in FIG. 1. As shown in FIG. 3A, memory controller 300 can include a processor 308 and internal memory including a cache 310 and a read-only memory (ROM) 311. In some implementations, processor 308 is implemented by microprocessors (e.g., digital signal processors (DSPs)) or microcontrollers (a.k.a. microcontroller units (MCUs)) that execute firmware modules to perform the various functions described herein. The various firmware modules in memory controller 300 described herein can be implemented as firmware codes or instructions stored in internal memory, for example, ROM 311, and executed by processor 308. In some implementations, processor 308 includes one or more hardware circuits, for example, fixed logic units such as a logic gate, a multiplexer, a flip-flop, a state machine, field-programmable gate arrays (FPGAs), programmable logic devices (PLDs). For example, the hardware circuits may include dedicated circuits performing a given logic function that is known at the time of device manufacture, such as application-specific integrated circuits (ASICs).

As shown in FIG. 3A, memory controller 300 can also include various input/output (I/O) interfaces (I/F), such as a non-volatile memory interface 312, a DRAM interface 314, and a host interface 316 coupled to a non-volatile memory device 302 (e.g., NAND Flash memory device, an example of memory device 104), DRAM 304 (e.g., an example of volatile memory devices), and a host 306 (e.g., an example of host 108), respectively. Non-volatile memory interface 312, DRAM interface 314, and host interface 316 can be configured to transfer data, command, clock, or any suitable signals between processor 308 and non-volatile memory device 302, DRAM 304, and host 306, respectively. Non-volatile memory interface 312, DRAM interface 314, and host interface 316 can implement any suitable communication protocols facilitating data transfer, communication, and management, such as the NVMe protocol and PCI-E protocol, double data rate (DDR) protocol, to name a few.

Both cache 310 and DRAM 304 may be considered volatile memory devices that can be controlled and accessed by memory controller 300 in a memory system. For example, cache 310 can be implemented as part of volatile memory devices, for example, by an SRAM and/or DRAM 304. It is understood that although FIG. 3A shows that cache 310 is within memory controller 300, and DRAM 304 is outside of memory controller 300. In some examples, both cache 310 and DRAM 304 may be within memory controller 300 or outside of memory controller 300.

Consistent with the scope of the present disclosure and disclosed below in detail, memory controller 300 can be configured to enter a low-temperature mode based on the temperature associated with non-volatile memory device 302, for example, in response to the temperature being lower than a threshold temperature. Memory controller 300 can be further configured to, in the low-temperature mode, control memory controller 300 itself and/or non-volatile memory device 302 to apply a low-temperature background operation schedule to increase the temperature associated with non-volatile memory device 302, for example, by transmitting a command to non-volatile memory device 302 to cause non-volatile memory device 302 to execute a set of background operations.

FIG. 3B illustrates example interactions between memory controller 300 and non-volatile memory device 302 of FIG. 3A, according to some aspects of the present disclosure. As described above with respect to FIG. 3A, memory controller 300 can include non-volatile memory interface 312 configured to communicate with non-volatile memory device 302. In some implementations, memory controller 300 may send, through non-volatile memory interface 312, at least one of address (ADDR) signals, control (CTRL) signals, or command (CMD) signals to non-volatile memory device 302. In some implementations, memory controller 300 may receive, through non-volatile memory interface 312, data to be stored in non-volatile memory device 302 from a host (e.g., host 108). Memory controller 300 can send, through non-volatile memory interface 312, a program command as well as the received data to non-volatile memory device 302 for storage. Alternatively or additionally, memory controller 300 can send, through non-volatile memory interface 312, a read command to non-volatile memory device 302 and retrieve data corresponding to the read command from non-volatile memory device 302.

In some implementations, memory controller 300 can control non-volatile memory device 302 to perform at least a first subset of a group of background operations based on a first schedule. In some implementations, memory controller 300 can transmit a notification to host 108 through indicating a low temperature event of the memory device. In some implementations, in response to an instruction from host 108, memory controller 300 can control non-volatile memory device 302 to perform at least a second subset of the group of background operations based on a second schedule different from the first schedule to increase a temperature associated with the memory device. In some implementations, the group of background operations comprises one or more of garbage collection, wear leveling, write booster, bad block management, wipe, defragmentation, and data retention management.

In some implementations, the first schedule indicates a first frequency of performing a first type of background operation in the first subset, the second schedule indicates a second frequency of performing the first type of background operation in the second subset, and the second frequency is greater than the first frequency. By executing one or more higher frequencies of one or more background operations, non-volatile memory device 302 can generate heat that directly increases its temperature (a.k.a. self-heating).

Consistent with the scope of the present disclosure and disclosed below in detail, memory controller 300 can be configured to implement various schemes to enter and exit the low-temperature mode. Memory controller 300 can terminate the preset idling operation after exiting the low-temperature mode. In some implementations, memory controller 300 can obtain the temperature associated with non-volatile memory device 302, and determine the low temperature event in response to the temperature being lower than a first threshold temperature or a decrease of the temperature being greater than a preset value. In some implementations, in response to the temperature being higher than a second threshold temperature, memory controller 300 can control non-volatile memory device 302 to exit the low-temperature mode to perform at least a third subset of a group of background operations based on a third schedule different from the second schedule.

In some implementations, processor 308 of memory controller 300 controls memory controller 300 to enter the low-temperature mode when the temperature associated with non-volatile memory device 302 is lower than a preset threshold temperature at the time of initializing non-volatile memory device 302, and also controls memory controller 300 to exit the low-temperature mode when the temperature associated with non-volatile memory device 302 becomes higher than another preset threshold temperature (target temperature) for a preset time period. Processor 308 of memory controller 300 can obtain the temperature associated with non-volatile memory device 302, for example, through one or more temperature sensors 110 shown in FIG. 1. When initializing non-volatile memory device 302 (e.g., when the mobile devices or vehicles having non-volatile memory device 302 is powering up), processor 308 of memory controller 300 can determine to enter the low-temperature mode in response to the temperature associated with non-volatile memory device 302 being lower than a first threshold temperature (e.g., minus 20 or 30 degrees Celsius). The first threshold temperature is preset, indicating an extremely cold environment in which read errors are likely to occur in non-volatile memory device 302, according to some implementations.

As described above, once entering the low-temperature mode, processor 308 of memory controller 300 can control memory controller 300 and/or non-volatile memory device 302 to terminate the first schedule of background operations and apply the second schedule of background operations to increase the temperature associated with non-volatile memory device 302. In the low-temperature mode, processor 308 of memory controller 300 can monitor (continuously or periodically) the temperature associated with non-volatile memory device 302 and determine to exit the low-temperature mode in response to the monitored temperature becoming higher than a second threshold temperature for a preset time period. In some implementations, the exit of the low-temperature mode includes termination of the second schedule of background operations and application of the third schedule of background operations. In some implementations, the second threshold temperature is a preset target temperature, indicating a suitable environment in which non-volatile memory device 302 can function well, according to some implementations. The time period for which the monitored temperature is maintained above the target temperature (e.g., 10 seconds) is preset to avoid random temperature spikes triggering the exit of the low-temperature mode, according to some implementations.

In some implementations, processor 308 of memory controller 300 controls memory controller 300 to enter the low-temperature mode when the temperature associated with non-volatile memory device 302 is lower than a first preset threshold temperature at the time, and also controls memory controller 300 to exit the low-temperature mode when the temperature associated with non-volatile memory device 302 is higher than a second preset threshold temperature at the time. Processor 308 of memory controller 300 can obtain the temperature associated with non-volatile memory device 302, for example, through one or more temperature sensors 110 shown in FIG. 1. Processor 308 of memory controller 300 can further determine to enter the low-temperature mode in response to the temperature associated with non-volatile memory device 302 being lower than a first threshold temperature (e.g., minus 20 or 30 degrees Celsius).

As described above, once entering the low-temperature mode, processor 308 of memory controller 300 can control memory controller 300 and/or non-volatile memory device 302 to apply a low-temperature background operation schedule to increase the temperature associated with non-volatile memory device 302. In the low-temperature mode, processor 308 of memory controller 300 can monitor (continuously or periodically) the temperature associated with non-volatile memory device 302 and determine to exit the low-temperature mode and terminate the low-temperature background operation schedule in response to the temperature associated with non-volatile memory device 302 being higher than the second preset threshold temperature, which indicates that non-volatile memory device 302 now can enter a normal-temperature background operation schedule in a normal temperature environment, according to some implementations.

In some implementations, processor 308 of memory controller 300 controls memory controller 300 to enter the low-temperature mode when receiving an instruction from host 306 indicating that the temperature associated with non-volatile memory device 302 is lower than a preset threshold temperature at the time, and also controls memory controller 300 to exit the low-temperature mode when receiving another instruction from host 306 indicating that the temperature associated with non-volatile memory device 302 now becomes higher than another preset threshold temperature (target temperature) for a preset time period. Host 306 can obtain the temperature associated with non-volatile memory device 302, for example, through one or more temperature sensors 110 shown in FIG. 1. Host 306 can also determine that the temperature associated with non-volatile memory device 302 is lower than a first threshold temperature (e.g., minus 20 or 30 degrees Celsius) and thus, send a first instruction to memory controller 300. In response, processor 308 of memory controller 300 can determine to enter the low-temperature mode. The first threshold temperature is preset, indicating an extremely cold environment in which read errors are likely to occur in non-volatile memory device 302, according to some implementations.

As described above, once entering the low-temperature mode, processor 308 of memory controller 300 can control memory controller 300 and/or non-volatile memory device 302 to apply a low-temperature background operation schedule to increase the temperature associated with non-volatile memory device 302. When memory controller 300 is in the low-temperature mode, host 306 can monitor (continuously or periodically) the temperature associated with non-volatile memory device 302 and determine that the monitored temperature has become higher than a second threshold temperature for a preset time period. Thus, host 306 can send a second instruction to memory controller 300, indicating the same. In response, processor 308 of memory controller 300 can determine to exit the low-temperature mode and terminate the low-temperature background operation schedule. The second threshold temperature is a preset target temperature, indicating a suitable environment in which non-volatile memory device 302 can function well, according to some implementations. The time period for which the monitored temperature is maintained above the target temperature (e.g., 10 seconds, 20 seconds, 30 seconds, 1 minute, etc.) is preset to avoid random temperature spikes triggering the exit of the low-temperature mode, according to some implementations.

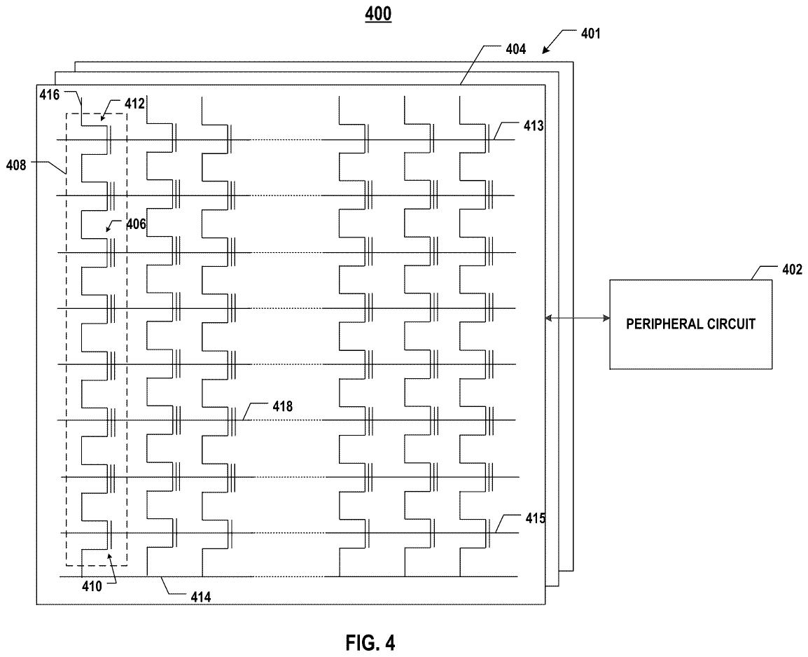

FIG. 4 illustrates a schematic circuit diagram of a NAND Flash memory device 400 including peripheral circuits 402, according to some aspects of the present disclosure. NAND Flash memory device 400 may be one example of non-volatile memory device 302 in FIG. 3A. NAND Flash memory device 400 can include a memory cell array 401 and peripheral circuits 402 coupled to memory cell array 401. Memory cells 406 in memory cell array 401 are provided in the form of an array of memory strings 408 each extending vertically above a substrate (not shown). In some implementations, each memory string 408 includes a plurality of memory cells 406 coupled in series and stacked vertically. Each memory cell 406 can hold a continuous, analog value, such as an electrical voltage or charge, which depends on the number of electrons trapped within a region of memory cell 406. Each memory cell 406 can be either a floating gate type of memory cell including a floating-gate transistor or a charge trap type of memory cell including a charge-trap transistor.

In some implementations, each memory cell 406 is a single-level cell (SLC) that has two possible levels (memory states) and thus, can store one bit of data. For example, the first state “0” can correspond to a first range of threshold voltages, and the second state “1” can correspond to a second range of threshold voltages. In some implementations, each memory cell 406 is an xLC that is capable of storing more than a single bit of data in more than four levels. For example, the xLC may store two bits per cell (a.k.a., multi-level cell (MLC)), three bits per cell (a.k.a., triple-level cell (TLC)), or four bits per cell (a.k.a. quad-level cell (QLC)). Each xLC can be programmed to assume a range of possible nominal storage values (i.e., corresponding to 2^{N} pieces of N-bits data). In some implementations, each memory cell 406 is set to one of 2^{N} levels corresponding to a piece of N-bits data, where N is an integer greater than 1. N may denote the total number of bits per cell. For example, N=2 for MLC, N=3 for TLC, or N=4 for QLC.

As shown in FIG. 4, each memory string 408 can also include a source select gate (SSG) transistor 410 at its source end and a drain select gate (DSG) transistor 412 at its drain end. SSG transistor 410 and DSG transistor 412 can be configured to activate select memory strings 408 (columns of the array) during read and program operations. In some implementations, the sources of memory strings 408 in the same block 404 are coupled through a same source line (SL) 414, e.g., a common SL. In other words, all memory strings 408 in the same block 404 have an array common source (ACS), according to some implementations. The drain of each memory string 408 is coupled to a respective bit line 416 from which data can be read or written via an output bus (not shown), according to some implementations. In some implementations, each memory string 408 is configured to be selected or deselected by applying a select voltage or a deselect voltage to the gate of respective DSG transistor 412 through one or more DSG lines 413 and/or by applying a select voltage or a deselect voltage to the gate of respective SSG transistor 410 through one or more SSG lines 415.

As shown in FIG. 4, memory strings 408 can be organized into multiple blocks 404, each of which can have a common source line 414, e.g., coupled to the ACS. In some implementations, each block 404 is the basic data unit for erase operations, i.e., all memory cells 406 on the same block 404 are erased at the same time. To erase memory cells 406 in a select block 404, source lines 414 coupled to select block 404 as well as unselect blocks 404 in the same plane as select block 404 can be biased with an erase voltage (Vers), such as a high positive bias voltage (e.g., 20 V or more).

Memory cells 406 of adjacent memory strings 408 can be coupled through word lines 418 that select which row of memory cells 406 is affected by read and program operations. Each word line 418 can include a plurality of control gates (gate electrodes) at each memory cell 406 coupled to word line 418 and a gate line coupling the control gates.

Peripheral circuits 402 can be operatively coupled to memory cell array 401 through bit lines 416, word lines 418, source lines 414, SSG lines 415, and DSG lines 413. Peripheral circuits 402 can include any suitable analog, digital, and mixed-signal circuits for facilitating the operations of memory cell array 401 by applying and sensing voltage signals and/or current signals to and from each select memory cell 406 through bit lines 416, word lines 418, source lines 414, SSG lines 415, and DSG lines 413. Peripheral circuits 402 can include various types of peripheral circuits formed using complementary metal-oxide-semiconductor (CMOS) technologies.

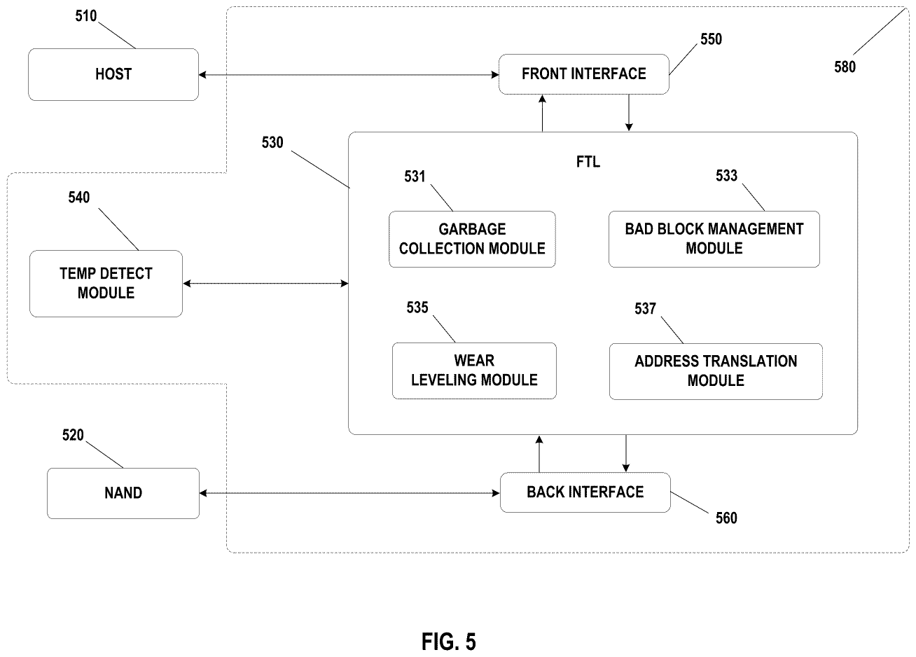

FIG. 5 illustrates an exemplary logic structure of a memory system, according to some aspects of the present disclosure. As shown in FIG. 5, the memory system can include a host 510, a NAND memory device 520, and a memory controller 580 connected between host 510 and NAND memory device 520. In some implementations, memory controller 580 can include a temperature detect module 540 configured to obtain the temperature associated with NAND memory device 520. For example, temperature detect module 540 can be configured to collect output information from one or more temperature sensors 110, as shown in FIG. 1.

In some implementations, memory controller 580 can include a flash translation layer (FTL) 530, which is a layer of firmware responsible for managing how data is written, stored, and retrieved in flash NAND memory device 520. In some implementations, flash translation layer 530 is coupled with host 510 through front interface 550, coupled with NAND memory device 520 through back interface 560, and can include a garbage collection module 531, a bad block management module 533, a wear leveling module 535, an address translation module 537, and any other suitable modules not shown in FIG. 5, such as a write booster module, a wipe operation management module, a defragmentation management module, a data retention management module, etc.

In some implementations, garbage collection module 531 is configured to reclaim invalid or obsolete data blocks to maintain write performance. In some implementations, bad block management module 533 is configured to identify and avoid defective blocks to prevent data corruption. In some implementations, wear leveling module 535 is configured to evenly distribute write and erase cycles across memory blocks to extend device lifespan. In some implementations, address translation module 537 is configured to handle logical-to-physical address mapping. In some implementations, the write booster module is configured to enhance write performance by using fast temporary storage, and other modules like the wipe operation management module, the defragmentation management module, and the data retention management module, are configured to ensure secure erasure, organize data efficiently, and preserve data integrity over time.

In some implementations, one or more modules in flash translation layer 530 can cause the memory controller 106 to control NAND memory device 520 to perform at least a first subset of a group of background operations based on a first schedule in a normal temperature mode. In some implementations, temperature detect module 540 can transmit, to host 510, a notification indicating a low temperature event of NAND memory device 520 based on the output information from one or more temperature sensors 110 shown in FIG. 1. In some implementations, in response to an instruction from host 510, the one or more modules in flash translation layer 530 can cause the memory controller 106 to control NAND memory device 520 to at least a second subset of the group of background operations based on a second schedule different from the first schedule.

In some implementations, the first schedule indicates a first frequency of performing a first type of background operation in the first subset, the second schedule indicates a second frequency of performing the first type of background operation in the second subset, and the second frequency is greater than the first frequency. By executing one or more higher frequencies of one or more background operations, NAND memory device 520 can generate heat that directly increases its temperature (a.k.a. self-heating).

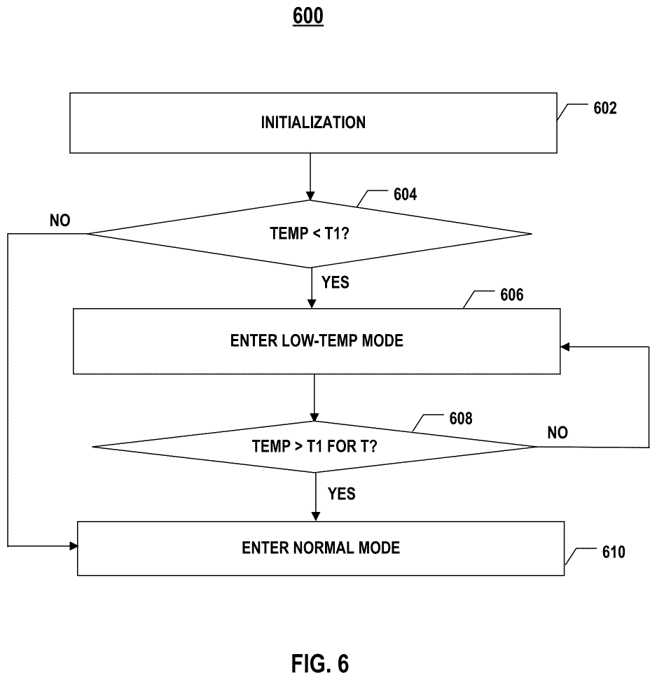

FIG. 6 illustrates an example process 600 for operating a memory system, according to some aspects of the present disclosure. The memory system may be any suitable memory system disclosed herein, such as memory system 102. By way of examples, FIG. 6 is described below with reference to memory controller 106 and memory device 104 without loss of generality. It is understood that the operations shown in process 600 may not be exhaustive and that other operations can be performed as well before, after, or between any of the illustrated operations. Further, some of the operations may be performed simultaneously, or in a different order than shown in FIG. 6. FIG. 6 illustrates an example of a low-temperature mode triggered by memory controller 106 during system initialization.

At operation 602, memory system 102 (and memory device 104) is initialized, for example, when the mobile devices or vehicles having memory system 102 are turned on. At operation 604, memory controller 106 obtains the temperature associated with memory device 104 TEMP and compares it with a first threshold temperature T1. If the temperature associated with memory device 104 TEMP is not lower than the first threshold temperature T1, at operation 610, memory controller 106 enters the normal mode, in which a first schedule of background operations is applied. If the temperature associated with memory device 104 TEMP is lower than the first threshold temperature T1, at operation 606, memory controller 106 enters the low-temperature mode to apply a second schedule of background operations to increase the temperature associated with memory device 104 TEMP, for example, by controlling memory device 104 and/or memory controller 106 to increase one or more frequencies of one or more background operations. At operation 608, memory controller 106 determines whether the temperature associated with memory device 104 TEMP has become higher than a second threshold temperature T2 for a time period T. If so, at operation 610, memory controller 106 exits the low-temperature mode and enters the normal mode, in which a third schedule of background operations is applied. Otherwise, process 600 returns to operation 606 in which memory controller 106 keeps in the low-temperature mode to continue increasing the temperature associated with memory device 104 TEMP.

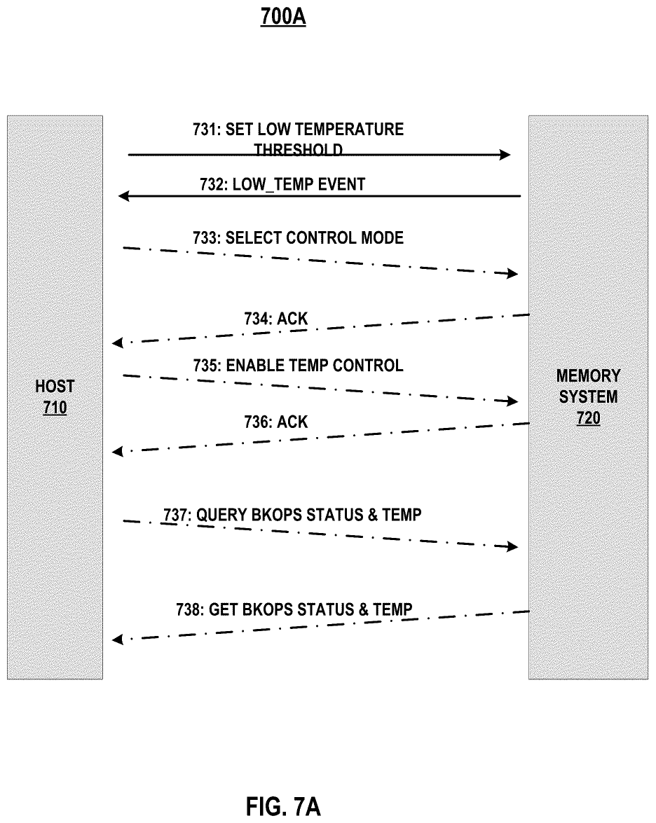

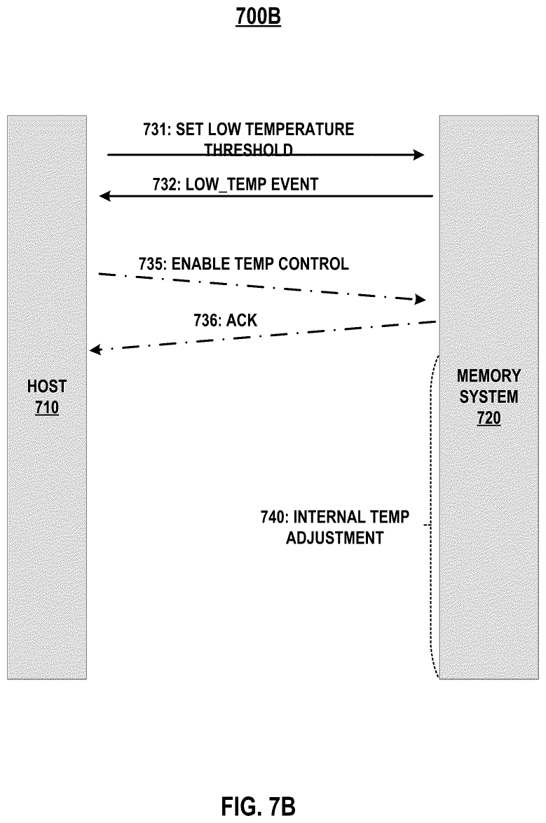

FIG. 7A illustrates an example operation sequence 700A for memory device temperature management, according to some aspects of the present disclosure. In some implementations, as shown in FIG. 7A, the operation steps and associated interface commands used in managing memory device temperature through communication between host 710 and memory system 720. Operation sequence 700A allows host 710 to be able to monitor and control the temperature of memory system 720 efficiently by adjusting background operations (BKOPS) schedules. It is understood that the operations shown in operation sequence 700A may not be exhaustive and that other operations can be performed as well before, after, or between any of the illustrated operations. Further, some of the operations may be performed simultaneously, or in a different order than shown in FIG. 7A.

In some implementations, operation sequence 700A begins with operation 731, in which host 710 sets a low-temperature threshold on the device. Using the “Set Threshold” interface, host 710 specifies a first operating temperature threshold for memory system 720. When memory system 720's temperature drops below the first operating temperature threshold, the memory controller in memory system 720 can generate a LOW_TEMP event notification and send the LOW_TEMP event notification to host 710 at operation 732. The first operating temperature threshold ensures that memory system 720 proactively informs host 710 of any low-temperature event, allowing host 710 to take appropriate action to maintain optimal operating conditions.

In some implementations, once the low-temperature threshold is configured, memory system 720 continuously monitors its operating temperature. If memory system 720 detects that the temperature falls below the specified threshold, memory system 720 triggers a low-temperature event and notifies host 710 through “LOW_TEMP” event mechanism, ensuring that host 710 is aware of memory system 720's thermal condition and can initiate control measures to address potential issues caused by the low-temperature environment.

In response to the low-temperature notification, host 710 proceeds with operation 733 to select a temperature control mode for memory system 720 using “Select Mode” interface. Memory system 720 can provide host 710 with a set of predefined temperature control modes, including options such as “strong,” “middle,” “weak,” or “adaptive.” These modes correspond to varying levels of background operation activity aimed at generating heat to raise memory system 720's temperature. For example, different modes can correspond to different background operation schedules, indicating different operation frequencies of one or more background operations. If host 710 does not explicitly configure a mode, memory system 720 defaults to a pre-selected low-temperature mode. However, host 710 can retain full control and can override the default to select a mode that aligns with its specific requirements or operational strategy.

After receiving the selected control mode configuration from host 710, memory system 720 acknowledges the received mode selection at operation 734, confirming that the selected control mode configuration has been successfully applied. This acknowledgment ensures that host 710 and memory system 720 are synchronized and that the appropriate mode is ready for execution. The acknowledgment also provides feedback to host 710, allowing it to confirm the implementation of its temperature management strategy.

Once the control mode has been selected and acknowledged, host 710 enables memory system 720's temperature adjustment functionality at operation 735 by issuing an enable command through “Enable Control” interface. In some implementations, “Enable Control” interface uses the geometry descriptor to activate memory system 720's temperature control system, allowing it to initiate background operations based on the selected mode. The enablement of temperature control is a critical step, as it allows the device to actively adjust its operating conditions to address the low-temperature environment.

Following the enable command, memory system 720 sends an acknowledgment to host 710 at operation 736, confirming that the temperature control feature has been successfully activated. This confirmation ensures that memory system 720 is fully prepared to apply the selected background operation schedule of performing background operations in accordance with the selected mode and is now actively managing memory system 720′ operation temperature. The acknowledgment provides assurance to the host that memory system 720's temperature adjustment system is operational and ready to respond to thermal changes.

Once temperature control is active, host 710 may periodically query memory system 720 for updates on its background operation status and real-time temperature at operation 737. In some implementations, operation 737 is performed using “Query” interface, which allows host 710 to request information about the progress and status of BKOPS as well as the current temperature of memory system 720. Operation 737 ensures that host 710 has access to up-to-date information regarding memory system 720's thermal and operational state, enabling real-time monitoring and decision-making.

In response to the query from host 710, memory system 720 provides a detailed report on its BKOPS status and current operating temperature on operation 738. This report enables host 710 to assess the effectiveness of the selected temperature control mode and determine whether additional adjustments are necessary. By providing real-time feedback, memory system 720 ensures that host 710 has full visibility into its thermal and operational performance, facilitating efficient and effective temperature management throughout the operation.

FIG. 7B illustrates another example operation sequence 700B for memory device temperature management, according to some aspects of the present disclosure. In some implementations, as shown in FIG. 7B, the operation steps and associated interface commands used in managing memory device temperature through communication between host 710 and memory system 720. Operation sequence 700B allows host 710 to give permission to memory system 720 to let memory system 720 efficiently self-control its operation temperature by automatically adjusting background operations (BKOPS) schedules. It is understood that the operations shown in operation sequence 700B may not be exhaustive and that other operations can be performed as well before, after, or between any of the illustrated operations. Further, some of the operations may be performed simultaneously, or in a different order than shown in FIG. 7B.

In some implementations, operation sequence 700B begins with operation 731, in which host 710 sets a low-temperature threshold on the device. Using the “Set Threshold” interface, host 710 specifies a first operating temperature threshold for memory system 720. When memory system 720's temperature drops below the first operating temperature threshold, memory system 720 can generate a LOW_TEMP event notification and send the LOW_TEMP event notification to host 710 at operation 732. The first operating temperature threshold ensures that memory system 720 proactively informs host 710 of any low-temperature event, allowing host 710 to take appropriate action to maintain optimal operating conditions.

In some implementations, once the low-temperature threshold is configured, memory system 720 continuously monitors its operating temperature. If memory system 720 detects that the temperature falls below the specified threshold, memory system 720 triggers a low-temperature event and notifies host 710 through “LOW_TEMP” event mechanism, ensuring that host 710 is aware of memory system 720's thermal condition and can initiate control measures to address potential issues caused by the low-temperature environment.

In response to the low-temperature notification, host 710 proceeds with operation 735 to send memory system 720 an auto-temperature adjustment enable command through “Enable Control” interface. In some implementations, “Enable Control” interface uses the geometry descriptor to activate memory system 720's temperature control system, allowing it to execute an auto-determine algorithm to determine a background operation schedule based on the temperature and a storage condition of memory system 720.

In some implementations, memory system 720 incorporates an auto-determine algorithm within its firmware to dynamically adjust the background operation schedule at operation 740 based on the device's temperature and storage condition. This algorithm evaluates the real-time temperature of the memory device and considers key storage parameters, such as the wear level, the number of bad blocks, and the utilization status of the memory. Based on these inputs, the algorithm determines an optimal schedule for executing background operations, such as garbage collection, wear leveling, write booster, and bad block management. To optimize device performance and thermal management, the optimal low-temperature background operation schedule generated by the auto-determine algorithm can instruct certain operations to be performed in advance or executed more frequently. As such, memory system 720 can dynamically adjust the schedule of background operations, either by prioritizing their execution earlier than usual or by increasing their frequency. This adaptive approach ensures efficient thermal regulation while maintaining the overall health and reliability of memory system 720.

For example, after receiving the auto-temperature adjustment enable command from host 710, memory system 720 may proactively initiate background operations to generate heat through increased internal activity, preventing the temperature from falling to levels that could impair performance. Additionally, background operations such as wear leveling or garbage collection may be triggered more frequently to ensure steady thermal output and optimal memory health. By intelligently modifying the schedule of these operations in the low-temperature mode, memory system 720 can achieve a balance between temperature management and long-term device performance, making it resilient in varying environmental conditions. By prioritizing operations that contribute to both temperature regulation and memory health, the auto-determine algorithm ensures efficient thermal management while maintaining the long-term performance and reliability of memory system 720. This adaptive approach enables memory system 720 to balance operational demands with thermal constraints dynamically, without requiring continuous input from host 710.

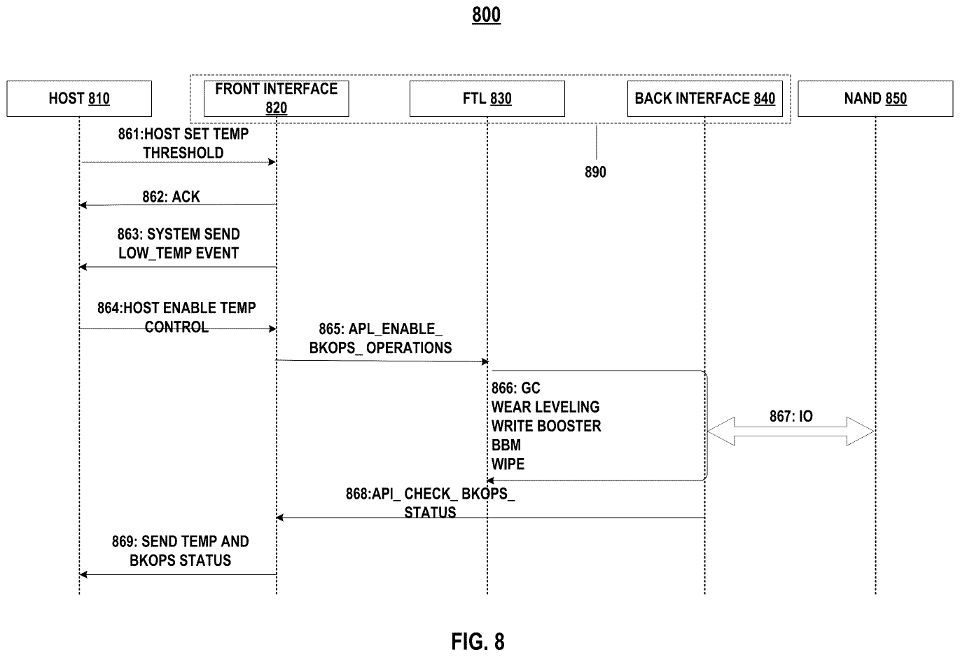

FIG. 8 illustrates an example operation sequence 800 for memory device temperature management, according to some aspects of the present disclosure. In some implementations, as shown in FIG. 8, the operation steps and associated interface commands are used in managing memory device temperature through communication between host 810 and a memory system including memory controller 890 and NAND memory device 850. In some implementations, memory controller 890 includes front interface 820, FTL 830, and back interface 840. Operation sequence 800 allows host 810 to monitor and control the temperature of NAND memory device 850 efficiently by adjusting background operations (BKOPS) schedules. It is understood that the operations shown in operation sequence 800 may not be exhaustive and that other operations can be performed as well before, after, or between any of the illustrated operations. Further, some of the operations may be performed simultaneously, or in a different order than shown in FIG. 8.

Operation sequence 800 begins with operation 861, in which host 810 sends a command to front interface 820 to set a low-temperature threshold. This command specifies a first temperature threshold to trigger a low-temperature event notification. By setting the low-temperature threshold, host 810 ensures that memory controller 890 can monitor the operating temperature of NAND 850 and notify host 810 if the operating temperature falls below the set limit.

Upon receiving the low-temperature threshold command, front interface 820 sends an acknowledgment back to host 810 at operation 862. This acknowledgment confirms that the memory system has successfully registered the low-temperature threshold and is ready to monitor its operating conditions accordingly. If the device's temperature falls below the configured threshold, front interface 820 generates a low-temperature event notification and sends it to host 810 at operation 863. This notification ensures that host 810 is promptly informed of the thermal condition and can take appropriate measures to manage the device's temperature.

In response to the low-temperature event notification, host 810 sends a command to front interface 820 to enable temperature control at operation 864. This command activates the device's temperature adjustment functionality, allowing it to adjust its operating conditions by performing specific background operations (BKOPS) to generate heat and raise its internal temperature. It is noted that, the specific schedule of executing background operations can be either selected by host 810, as described above, in connection with FIG. 7A, or can be auto-determined by flash translation layer (FTL) 830, as described above in connection with FIG. 7B.

Upon receiving the enable command, front interface 820 communicates with FTL 830 to enable a low-temperature schedule of background operations at operation 865 based on a selected temperature control mode from host 810, or to enable an auto-determine algorithm based on permission from host 810. The low-temperature schedule of background operations corresponding to the selected mode determines the intensity and frequency of background operations, with options such as “strong,” “middle,” “weak,” or “adaptive,” depending on the level of heat generation required.

Within FTL 830, the temperature control algorithm and/or auto-determine algorithm in the firmware evaluates NAND memory device 850's current temperature and storage conditions, and determines the specific background operations to execute at operation 866. The algorithm may initiate one or more background operations, including garbage collection (GC), wear leveling, write booster, bad block management (BBM), wipe operations, etc. These background operations are strategically chosen to generate heat while ensuring NAND memory device 850 remains operational and efficient. The FTL 830 then issues commands to back interface 840, which interacts with NAND memory device 850 to perform the background operations on the memory array at operation 867. These background operations are executed directly on the NAND flash memory based on the low-temperature schedule, resulting in controlled heat generation and contributing to the stabilization of NAND memory device 850's operating temperature.

After executing the background operations, back interface 840 reports the status of background operations and the current temperature to front interface 820 at operation 868. This step provides real-time updates on the progress of temperature control and ensures that the front interface has the necessary information to communicate with host 810. Finally, front interface 820 sends NAND memory device 850's current temperature and background operations status back to host 810 at operation 869. This feedback allows host 810 to monitor the effectiveness of the temperature control measures and determine if further adjustments or interventions are required.

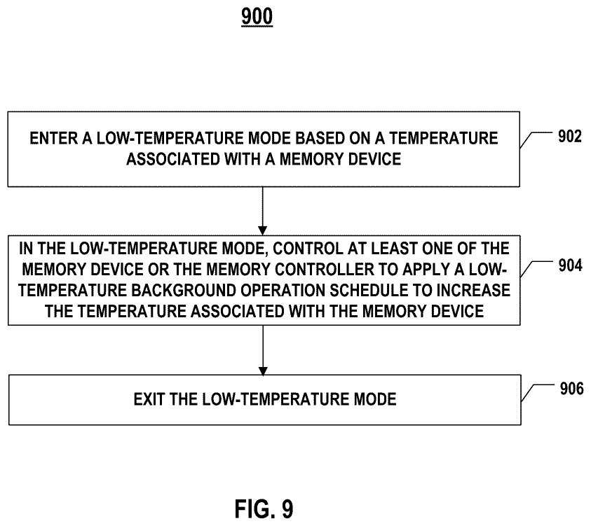

FIG. 9 illustrates a flowchart of a method 900 for operating a memory controller, according to some aspects of the present disclosure. The memory controller may be any suitable memory controller disclosed herein, such as memory controller 106. The memory controller may be coupled to a memory device and control the operation of the memory device. The memory device may be any suitable memory device disclosed herein, such as memory device 104 (e.g., non-volatile memory device 302, NAND memory device 520). By way of examples, FIG. 9 is described below with reference to memory controller 106, as well as memory device 104 and host 108, without loss of generality. It is understood that the operations shown in method 900 may not be exhaustive and that other operations can be performed as well before, after, or between any of the illustrated operations. Further, some of the operations may be performed simultaneously, or in a different order than shown in FIG. 9.

Referring to FIG. 9, method 900 starts at operation 902, in which a low-temperature mode is entered based on a temperature associated with a memory device. For example, as shown in FIG. 1, memory controller 106 may enter a low-temperature mode based on a temperature associated with memory device 104. In some implementations, the temperature associated with the memory device is obtained, and it is determined to enter the low-temperature mode in response to the temperature being lower than a first threshold temperature when initializing the memory system. For example, as shown in FIGS. 1 and 6, memory controller 106 may obtain TEMP from temperature sensor 110 and determine to enter the low-temperature mode in response to TEMP being lower than T1 during initialization.

Method 900 proceeds to operation 904, as illustrated in FIG. 9, in which in the low-temperature mode, at least one of the memory device or the memory controller is controlled to apply a low-temperature background operation schedule to increase the temperature associated with the memory device. For example, as shown in FIG. 1, memory controller 106 may control memory controller 106 and/or memory device 104 to apply a low-temperature background operation schedule to increase the temperature associated with memory device 104.

Method 900 proceeds to operation 906, as illustrated in FIG. 9, in which the low-temperature mode is exited. In some implementations, it is determined to exit the low-temperature mode in response to the temperature being higher than a second threshold temperature for a preset time period. For example, as shown in FIGS. 1 and 6, in the low-temperature mode, memory controller 106 may monitor TEMP from temperature sensor 90 and determine to exit the low-temperature mode and terminate the idling operation in response to TEMP being higher than T2 for T. In the normal-temperature mode, at least one of the memory device or the memory controller is controlled to apply a normal-temperature background operation schedule.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a memory controller, such as memory controller 300 in FIG. 3A. By way of example, and not limitation, such computer-readable media can include RAM, ROM, electrically erasable programmable ROM (EEPROM), compact disc read-only memory (CD-ROM) or other optical disk storage, hard disk drive (HDD), such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk where disks usually reproduce data magnetically, while discs reproduce data optically with lasers. Combinations of the above should also be included within the scope of computer-readable media.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations, but should be defined only in accordance with the following claims and their equivalents.

Although specific configurations and arrangements are discussed, it should be understood that this is done for illustrative purposes only. As such, other configurations and arrangements can be used without departing from the scope of the present disclosure. Also, the subject matter as described in the present disclosure can also be used in a variety of other applications. Functional and structural features as described in the present disclosures can be combined, adjusted, modified, and rearranged with one another and in ways that are consistent with the scope of the present disclosure.

1. A memory system, comprising:
a memory device; and
a memory controller coupled to the memory device and configured to:
control the memory device to perform at least a first subset of a group of background operations based on a first schedule;
transmit a notification to a host indicating a low temperature event of the memory device; and
in response to an instruction from the host, control the memory device to perform at least a second subset of the group of background operations based on a second schedule different from the first schedule to increase a temperature associated with the memory device;
wherein each of the first subset and the second subset of the group of background operations comprises at least two different types of background operations.

2. The memory system of claim 1, wherein the group of background operations comprises:
background operations of two or more of garbage collection, wear leveling, write booster, bad block management, wipe, defragmentation, and data retention management.

3. The memory system of claim 1, wherein:
the first schedule indicates a first frequency of performing a first type of background operation in the first subset;
the second schedule indicates a second frequency of performing the first type of background operation in the second subset; and
the second frequency is greater than the first frequency.

4. The memory system of claim 1, wherein the memory controller is further configured to:
obtain the temperature associated with the memory device; and
determine the low temperature event in response to the temperature being lower than a first threshold temperature or a decrease of the temperature being greater than a preset value.

5. The memory system of claim 4, wherein the memory controller is further configured to:
in response to a permission indicated by the instruction, enable an auto-determine algorithm to determine the second schedule based on the temperature and a storage condition of the memory device.

6. The memory system of claim 4, wherein the memory controller is further configured to:
in response to a host selection indicated by the instruction, select, from a plurality of predetermined schedule options, the second schedule corresponding to the host selection.

7. The memory system of claim 4, wherein the memory controller is further configured to:
in response to the temperature being higher than a second threshold temperature, control the memory device to perform at least a third subset of a group of background operations based on a third schedule different from the second schedule.

8. The memory system of claim 4, wherein the memory controller is further configured to:
generate a real-time status report of the background operations and the temperature; and
send the real-time status report to the host.

9. A method, comprising:
controlling a memory device to perform at least a first subset of a group of background operations based on a first schedule;
transmitting a notification to a host indicating a low temperature event of the memory device; and
in response to an instruction from the host, controlling the memory device to perform at least a second subset of the group of background operations based on a second schedule different from the first schedule to increase a temperature associated with the memory device;
wherein each of the first subset and the second subset of the group of background operations comprises at least two different types of background operations.

10. The method of claim 9, wherein:
the first schedule indicates a first frequency of performing a first type of background operation in the first subset;
the second schedule indicates a second frequency of performing the first type of background operation in the second subset; and
the second frequency is greater than the first frequency.

11. The method of claim 9, further comprising:
obtaining the temperature associated with the memory device; and
determining the low temperature event in response to the temperature being lower than a first threshold temperature or a decrease of the temperature being greater than a preset value.

12. The method of claim 9, further comprising:
in response to a permission indicated by the instruction, enabling an auto-determine algorithm to determine the second schedule based on the temperature and a storage condition of the memory device.

13. The method of claim 9, further comprising:
in response to a host selection indicated by the instruction, selecting, from a plurality of predetermined schedule options, the second schedule corresponding to the host selection.

14. The method of claim 9, further comprising:
generating a real-time status report of the background operations and the temperature; and
sending the real-time status report to the host.

15. A non-transitory computer-readable storage medium comprising instructions that, when executed by a memory controller coupled with a memory device, cause the memory controller to perform a method comprising:
controlling the memory device to perform at least a first subset of a group of background operations based on a first schedule;
transmitting a notification to a host indicating a low temperature event of the memory device; and
in response to an instruction from the host, controlling the memory device to perform at least a second subset of the group of background operations based on a second schedule different from the first schedule to increase a temperature associated with the memory device;
wherein each of the first subset and the second subset of the group of background operations comprises at least two different types of background operations.

16. The non-transitory computer-readable storage medium of claim 15, wherein:
the first schedule indicates a first frequency of performing a first type of background operation in the first subset;
the second schedule indicates a second frequency of performing the first type of background operation in the second subset; and
the second frequency is greater than the first frequency.

17. The non-transitory computer-readable storage medium of claim 15, wherein the method further comprises:
obtaining the temperature associated with the memory device; and
determining the low temperature event in response to the temperature being lower than a first threshold temperature or a decrease of the temperature being greater than a preset value.

18. The non-transitory computer-readable storage medium of claim 15, wherein the method further comprises:
in response to a permission indicated by the instruction, enabling an auto-determine algorithm to determine the second schedule based on the temperature and a storage condition of the memory device.

19. The non-transitory computer-readable storage medium of claim 15, wherein the method further comprises:
in response to a host selection indicated by the instruction, selecting, from a plurality of predetermined schedule options, the second schedule corresponding to the host selection.

20. The non-transitory computer-readable storage medium of claim 15, wherein the method further comprises:
generating a real-time status report of the background operations and the temperature; and
sending the real-time status report to the host.
